(19) United States
(12) Patent Application Publication
(10) Pub. No.: US 2022/0096877 A1
(43) Pub. Date: Mar. 31, 2022

(54) MASK MANUFACTURING MACHINE

(71) Applicant: AUTOLAND TECHNOLOGY CO., LTD., Tainan City (TW)

(72) Inventor: Shao-Ju CHEN, Tainan City (TW)

(21) Appl. No.: 17/158,595

(22) Filed: Jan. 26, 2021

(30) Foreign Application Priority Data
Sep. 28, 2020 (TW) 109133672

(51) Int. Cl. A62B 18/08; A62B 23/02; A41D 13/11

(52) U.S. Cl. CPC A62B 18/084; A41D 13/1161; A62B 23/025

(57) ABSTRACT

A mask manufacturing machine includes a carrying frame, a strap conveying apparatus and a strap fixing apparatus. The carrying frame is adapted for supporting and positioning a cover body of a mask thereon. The strap conveying apparatus includes at least one conveying device that is adapted for conveying a strap to a location under the carrying frame, and that has two clamping units adapted for clamping respectively two opposite ends of the strap, and moving respectively the ends of the strap to contact a top surface of the cover body. The strap fixing apparatus includes two hot pressing devices adapted for bonding respectively the ends of the strap to the top surface of the cover body by hot-melting.

### CROSS-REFERENCE TO RELATED APPLICATION

This application claims priority of Taiwanese Patent Application No. 109133672, filed on Sep. 28, 2020.

### FIELD

The disclosure relates to a manufacturing machine, and more particularly to a mask manufacturing machine.

### BACKGROUND

In terms of effectively preventing the spread of novel coronavirus and other droplet-transmitted diseases, wearing masks is currently the most economical and convenient basic protective measure. In order to quickly acquire a large number of masks, governments of various countries have, aside from importing surgical masks from other countries, successively invested in the development and manufacture of automated mask manufacturing machines.

### SUMMARY

Therefore, the object of the disclosure is to provide an automated mask manufacturing machine.

According to the disclosure, a mask manufacturing machine is adapted for processing and bonding a strap onto a cover body so as to manufacture a mask. The mask manufacturing machine includes a cover carrying mechanism and at least one strap mounting mechanism. The cover carrying mechanism includes a carrying frame adapted for supporting and positioning the cover body thereon.

The at least one strap mounting mechanism includes a strap conveying apparatus and a strap fixing apparatus. The strap conveying apparatus includes at least one conveying device adapted for conveying the strap to a location under the carrying frame. The at least one conveying device has two driving units that are spaced apart from each other, and two clamping units that are mounted respectively to the driving units and that are adapted for clamping respectively two opposite ends of the strap. Each of the clamping units is drivable by a respective one of the driving units to turn upwardly, so as to move a respective one of the ends of the strap to contact a top surface of the cover body. The strap fixing apparatus includes two spaced-apart hot pressing devices. Each of the hot pressing devices is adapted for bonding the respective one of the ends of the strap to the top surface of the cover body by hot-melting.

The effect of the present disclosure resides in that, through the structural design of the cover carrying mechanism and the strap mounting mechanism, the strap can be automatically manufactured and bonded onto the cover body.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary perspective view of an embodiment of a mask manufacturing machine according to the disclosure;

FIG. 2 is a fragmentary top view of the embodiment illustrating a strap mounting mechanism that corresponds in position to a carrying frame at a first processing position;

FIG. 3 is a fragmentary top view of the embodiment illustrating another strap mounting mechanism that corresponds in position to the carrying frame at a second processing position;

FIG. 4 is a fragmentary perspective view of the embodiment illustrating a portion of the carrying frame disposed at a positioning position;

FIG. 5 is a fragmentary side view of the embodiment;

FIG. 6 is a fragmentary top view of the embodiment illustrating a string pulling device at a holding position;

FIG. 7 is a view similar to FIG. 6, illustrating the string pulling device at a pulled-away position;

FIG. 8 is a view similar to FIG. 7, illustrating a clamping device that clamps a string at a clamping position, and a string cutting device that cuts the string;

FIG. 9 is a view similar to FIG. 8, illustrating the clamping device clamping a strap and being converted to a feeding position;

FIG. 10 is a view similar to FIG. 9 illustrating the clamping device moving the strap to a location under the carrying frame;

FIG. 11 is a view similar to FIG. 10, illustrating the clamping device placing respectively opposite ends of the strap at two first strap-fixing regions of a cover body;

FIG. 12 is a fragmentary perspective view of the embodiment illustrating a strap fixing apparatus; and

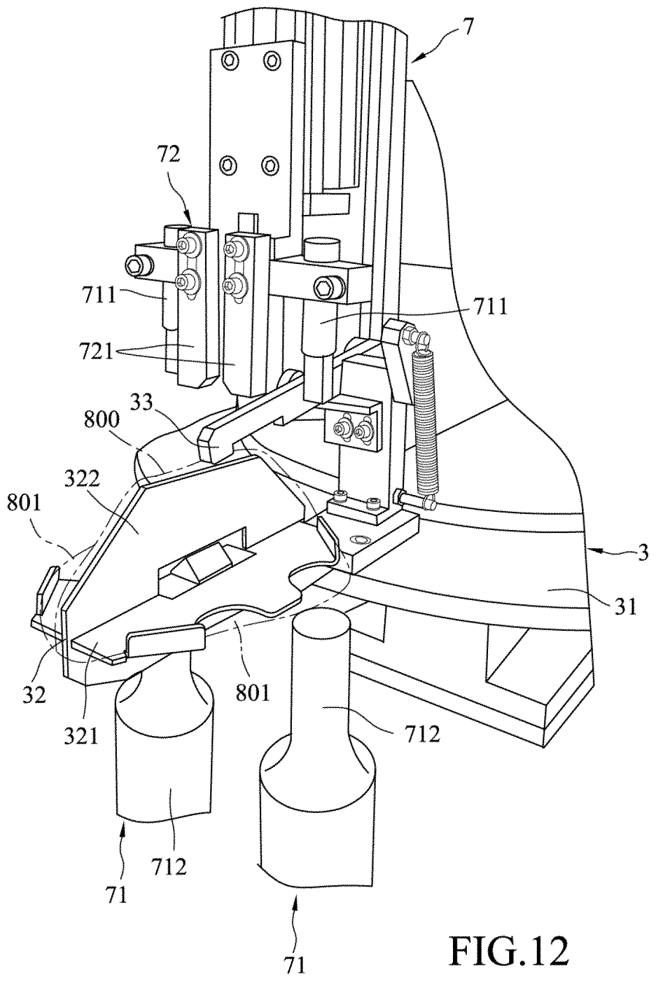

FIG. 13 is a view similar to FIG. 12, illustrating the strap fixing apparatus hot melting and hot pressing the ends of the strap on the cover body.

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

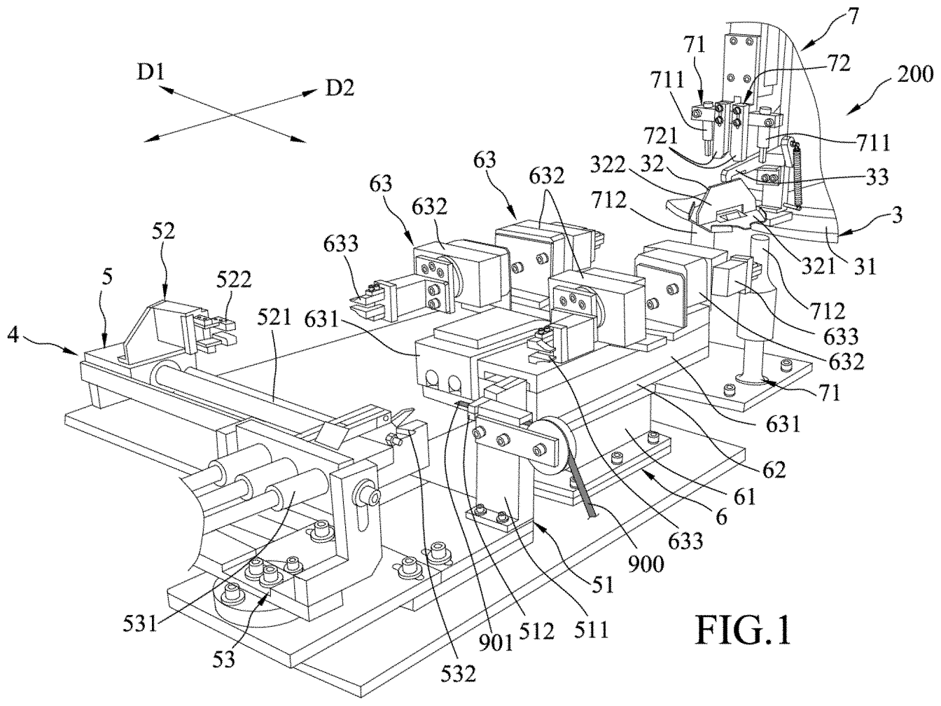

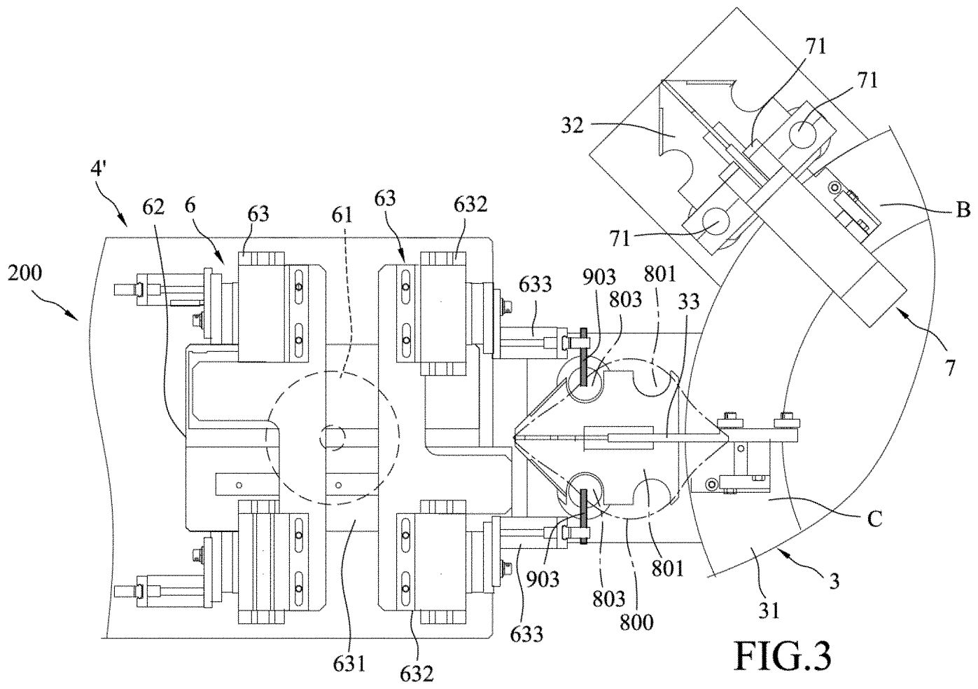

Referring to FIGS. 1, 2 and 3, an embodiment of a mask manufacturing machine 200 according to the disclosure is adapted for processing and bonding a strap 902 onto a cover body 800 so as to manufacture a mask. In the present embodiment, the mask is a 3D mask (i.e., a fold-flat mask). The cover body 800 has two first strap-fixing regions 802 and two second strap-fixing regions 803. Specifically, the cover body 800 includes two cloth pieces 801 that are connected together to form a cup shape with an opening facing downward, and that each have a respective one of the first strap-fixing regions 802 and a respective one of the second strap-fixing regions 803.

The mask manufacturing machine 200 is adapted to fix two opposite ends 903 of the strap 902 to the first strap-fixing regions 802 of the cover body 80, and the ends 903 of an additional strap 902 to the second strap-fixing regions 803 of the cover body 80. The mask manufacturing machine 200 includes a cover carrying mechanism 3 and two strap mounting mechanisms 4, 4′.

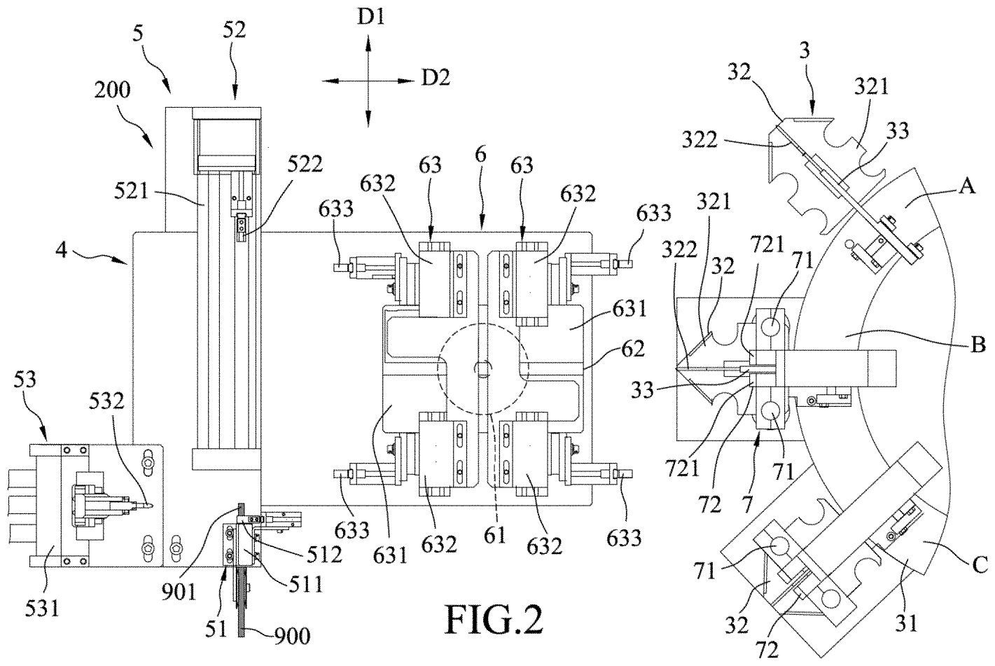

Referring to FIGS. 2, 3 and 4, the cover carrying mechanism 3 includes a transferring mechanism 31, a plurality of carrying frames 32 and a plurality of pressers 33.

The transferring mechanism 31 is provided for the carrying frames 32 to be mounted thereto and for transferring each of the carrying frames 32 among a positioning position (A), a first processing position (B) and a second processing position (C). Each of the carrying frames 32 is adapted for supporting and positioning the cover body 800 thereon with the opening of the cover body 800 facing downward, and has a base seat 321 and a supporting piece 322.

For each of the carrying frames 32, the base seat 321 is adapted for the cover body 800 (i.e., the two cloth pieces 801) to be disposed thereon, and the supporting piece 322 extends upwardly from a top surface of the base seat 321 and is adapted for supporting a middle portion of the cover body 800 such that the middle portion is higher than the rest of the cover body 800.

In the present embodiment, the transferring mechanism 31 transfers the carrying frames 32 among the positioning position (A), the first processing position (B) and the second processing position (C) by rotation. However, in variations of the embodiment, the carrying frames 32 may be transferred among the above-mentioned positions by various means (e.g., the carrying frames 32 maybe transferred in a linear manner along a predetermined direction), and thus details of the transferring means are not further described hereinafter.

Each of the pressers 33 is transferrable with a respective one the carrying frames 32 by the transferring mechanism 31, and is drivable to press the middle portion of the cover body 800 against the supporting piece 322 of the respective one the carrying frames 32 for positioning the middle portion of the cover body 800. The pressers 33 are drivable by various drive mechanisms (e.g., by an electric motor), and thus details of the drive mechanisms are not further described hereinafter.

The strap mounting mechanisms 4, 4′ correspond in position to the first and second processing positions (B, C), respectively. Each of the strap mounting mechanisms 4, 4′ is adapted to bond the corresponding strap 902 to the first strap-fixing regions 802 or the second strap-fixing regions 803 of the cover body 800. Since the two strap mounting mechanisms 4, 4′ are substantially the same in terms of structure and operation, for the sake of brevity, the following paragraphs only describe structural and operational details of one of the strap mounting mechanisms 4, 4′ (i.e., the one denoted by 4) that is adapted to work with the first strap-fixing regions 802 of the cover body 800.

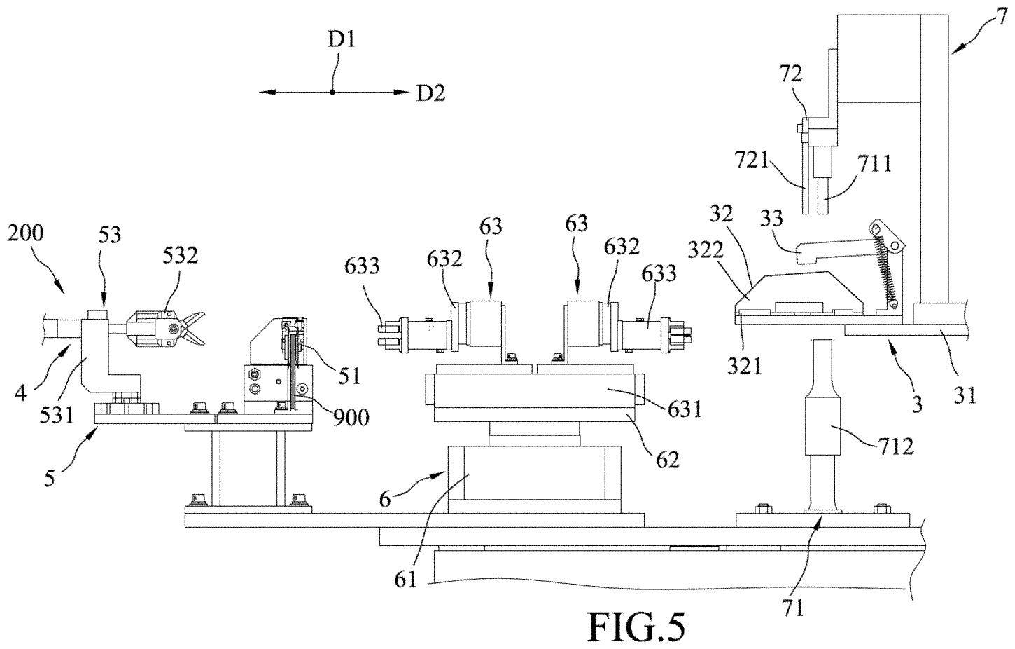

Referring to FIGS. 1, 2 and 5, the strap mounting mechanism 4 includes a feeding apparatus 5, a strap conveying apparatus 6 and a strap fixing apparatus 7.

The feeding apparatus 5 includes a string guiding device 51, a string pulling device 52 and a string cutting device 53. The string guiding device 51 includes a string seat 511 that is adapted for a string 900 to extend therethrough in a horizontal first direction (D1), and a clamping member 512 that is adapted for clamping a free end 901 of the string 900 extending movably through the string seat 511.

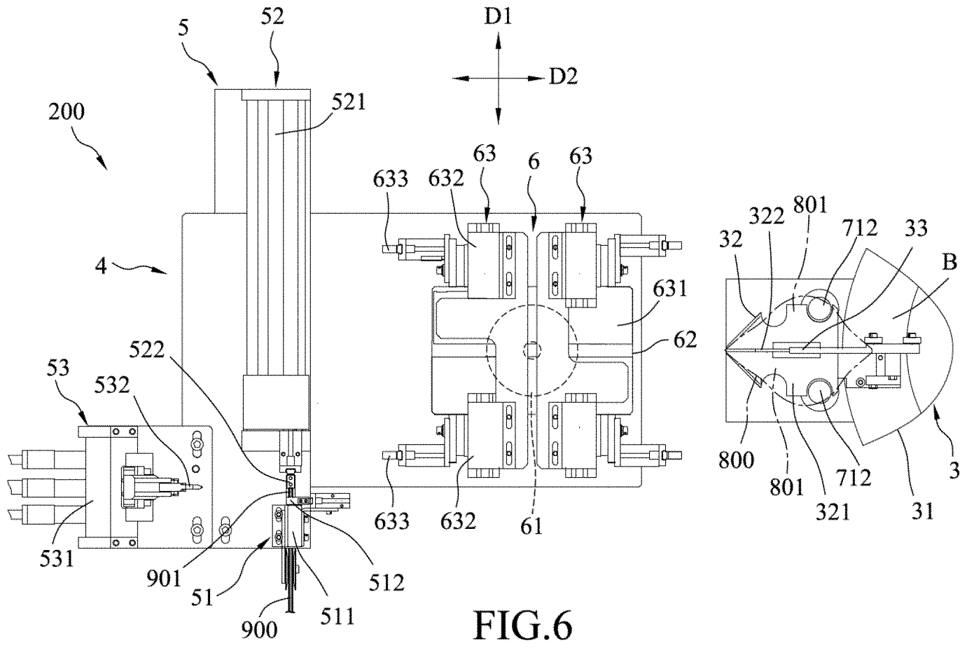

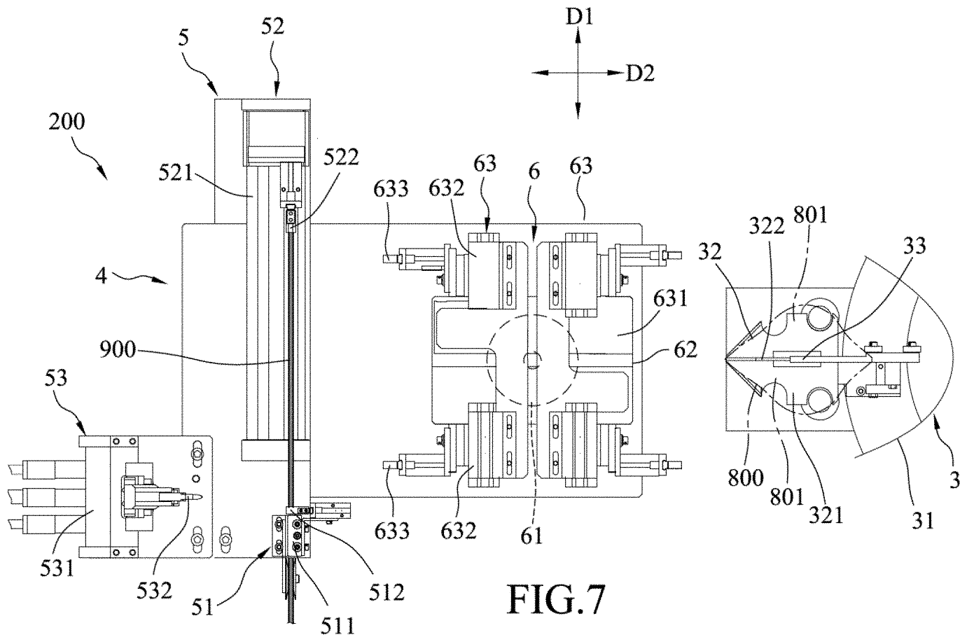

The string pulling device 52 is adapted for clamping and pulling the free end 901 of the string 900 away from the string guiding device 51. Specifically, the string pulling device 52 includes a first adjustment unit 521 and a string puller 522 that is mounted to the first adjustment unit 521. In the present embodiment, the first adjustment unit 521 includes a track that extends horizontally in the first direction (D1), and is drivable to move the string puller 522 along the track between a holding position (see FIG. 6) and a pulled-away position (see FIG. 7). When at the holding position, the string puller 522 is proximate to the string guiding device 51, and is operated to clamp the free end 901 of the string 900. When at the pulled-away position, the string puller 522 is distal from the string guiding device 51 such that the free end 901 of the string 900 is pulled away from the string guiding device 51 when the string puller 522 is moved from the holding position to the pulled-away position.

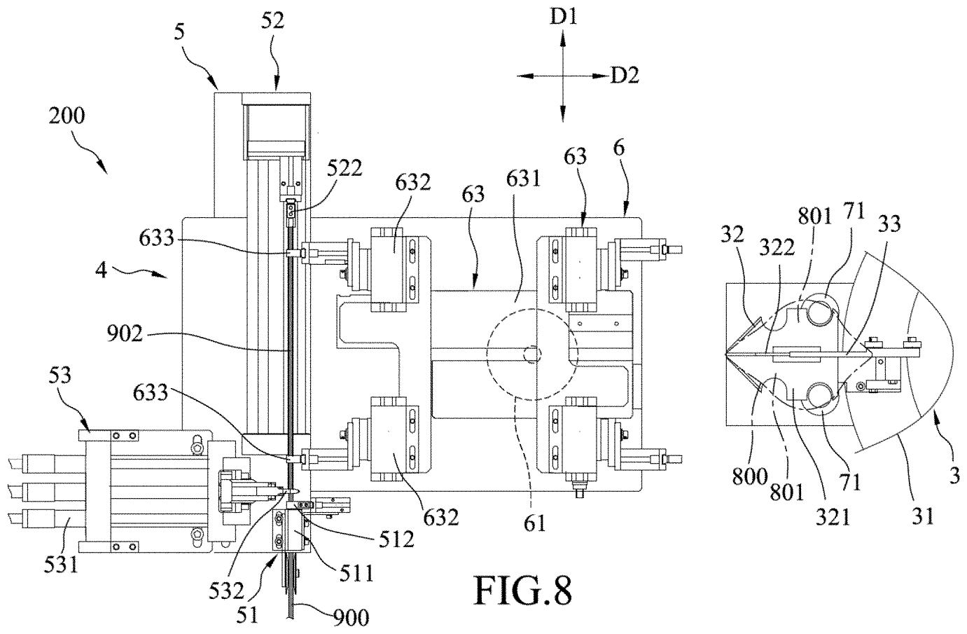

The string cutting device 53 is adapted for cutting the string 900 after the free end 901 is pulled away from the string guiding device 51 (see FIG. 8). Specifically, the string cutting device 53 includes a second adjustment unit 531 and a string cutter 532 that is mounted to the second adjustment unit 531. In the present embodiment, the second adjustment unit 531 includes a telescopic cylinder that is extendable in a horizontal second direction (D2) which is non-parallel to the first direction (D1). The second adjustment unit 531 is drivable to move the string cutter 532 in the second direction (D2) toward the clamping member 512. The string cutter 532 is adapted to cut the string 900 such that a portion of the string 900, which has the free end 901 and which is cut off from the rest of the string 900, forms the strap 902 (i.e., the free end 901 of the string 900 now becomes one of the opposite ends 903 of the strap 902). In the present embodiment, the second direction (D2) is perpendicular to the first direction (D1), but is not limited thereto.

Apart from the track and the telescopic cylinder described above, the first adjustment unit 521 and the second adjustment unit 531 of the present embodiment may include, but not limited to, threaded rods for power transmission so as to drive the movements of the string puller 522 and the string cutter 532, respectively. In addition, in the present embodiment, the clamping member 512 and the string puller 522 are both pneumatic clamps, which can be driven individually to clamp or release the string 900, and the string cutter 532 is also a pneumatic machine which can be driven to cut the string 900. Since configurations of the clamping member 512, the string puller 522, and the string cutter 532 may vary widely, they will not be described in further detail hereinafter.

Referring to FIGS. 1, 2 and 5, the strap conveying apparatus 6 of the one of the strap mounting mechanisms 4, 4′ (denoted by 4) is adapted to move the ends 903 of the strap 902 to contact respectively the first strap fixing regions 802 of the cover body 80; and the strap conveying apparatus 6 of the other one of strap mounting mechanisms 4, 4′ (denoted by 4′) is adapted to move the ends 903 of the additional strap 902 to contact respectively the second strap fixing regions 803 of the cover body 80.

Specifically, for each of the strap mounting mechanisms 4, 4′, the strap conveying apparatus 6 includes a driving device 61, a rotating seat 62 that is disposed above the driving device 61, and two conveying devices 63 that are mounted atop the rotating seat 62. The driving device 61 is connected to the rotating seat 62 for driving the rotating seat 62 to rotate horizontally. In the present embodiment, one of the conveying devices 63 is disposed proximate to the feeding apparatus 5 at a clamping position, and the other one is disposed proximate to the carrying frame 32 at a feeding position. The conveying devices 63 are co-rotatable with the rotating seat 62 such that, when each of the conveying devices 63 is converted between the clamping position and the feeding position, the positions of the conveying devices 63 are interchanged.

More specifically, the conveying devices 63 are adapted for conveying the strap 902 to a location under the carrying frame 32, and each of the conveying devices 63 includes a translating unit 631, two driving units 632, and two clamping units 633.

For each of the conveying devices 63, the translating unit 631 is mounted to the rotating seat 62 and is horizontally movable relative to the rotating seat 62; the driving units 632 are spaced apart from each other and are mounted to and co-movable with the translating unit 631; and the clamping units 633 are mounted respectively to the driving units 632 and are adapted for clamping respectively the ends 903 of the strap 902.

When one of the conveying devices 63 is at the clamping position, the driving unit 632 thereof drives the clamping unit 633 to clamp the strap 902, and the clamping unit 633 thereof is operated to clamp the strap 902. When the one of the conveying devices 63 is converted from the clamping position to the feeding position, the driving unit 632 thereof drives the clamping unit 633 to move the strap 902 to the location under the carrying frame 32 (i.e., the clamping unit 633 is disposed under the carrying frame 32). Then, each of the clamping units 633 is drivable by a respective one of the driving units 632 to turn upwardly, so as to move a respective one of the ends 903 of the strap 902 to contact a top surface of the cover body 800.

The strap fixing apparatus 7 includes two spaced-apart hot pressing devices 71 and a positioning device 72.

Each of the hot pressing devices 71 is adapted for bonding the respective one of the ends 903 of the strap 902 to the top surface of the cover body 800 by hot-melting. Each of the hot pressing devices 71 includes a heater 712 and an abutment seat 711 that are disposed under and over the carrying frame 32, respectively, and that are drivable to move vertically toward each other, so as to clamp and hot-melt a corresponding one of the ends 903 of the strap 902 and the cover body 800 together. In the present embodiment, the heater 712 is a high frequency heater, but is not limited thereto.

The positioning device 72 is connected to the abutment seat 711 of each of the hot pressing devices 71, is disposed over the carrying frame 32, and is movable synchronously with the heater 712 and the abutment seat 711 of each of the hot pressing devices 71 to press the cover body 800 against the carrying frame 32 for positioning the cover body 800. The positioning device 72 has two spaced-apart positioners 721 that are adapted for positioning respectively the cloth pieces 801 by pressing the same against the top surface of the base seat 321 of the carrying frame 32, such that the hot pressing devices 71 press respectively against the first strap-fixing regions 802. However, in other embodiments of the disclosure, the positioning device 72 may not be connected to the abutment seat 711.

In an actual operation of the mask manufacturing machine 200, the cover body 800 may be disposed on the carrying frame 32 via other equipment, and the cover carrying mechanism 3 and the strap mounting mechanisms 4, 4′ may be controlled via automation control equipment.

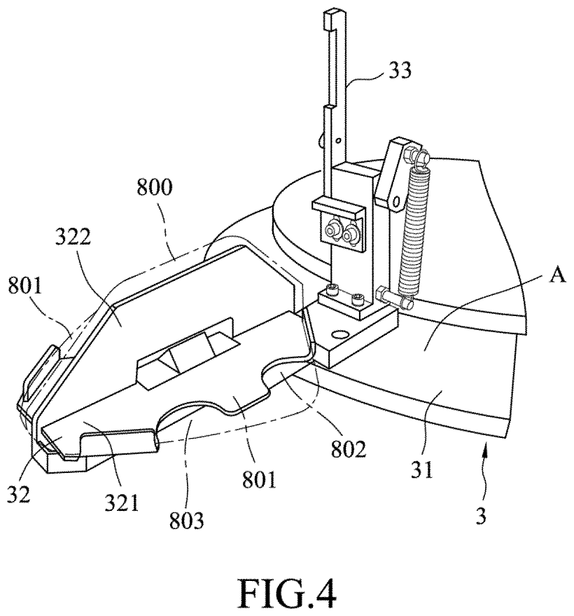

Referring to FIGS. 4, 6, and 7, at the beginning of an operation of the present embodiment, the cover body 800 is disposed on the carrying frame 32, and the carrying frame 32 is transferred to the positioning position (A). Next, the presser 33 is driven to press and position the cover body 800 on the carrying frame 32, and the transferring mechanism 31 then moves the carrying frame 32 to the first processing position (B).

Then, the feeding apparatus 5 of the strap mounting mechanism 4 corresponding to the first processing position (B) is driven, and the string pulling device 52 thereof is driven to clamp the free end 901 of the string 900. The string guiding device 51 then drives the clamping member 512 thereof to release the string 900, allowing the string pulling device 52 to pull the string 900 away from the string seat 511 (i.e., from the holding position to the pulled-away position), and the clamping member 512 is driven to clamp the string 900 again.

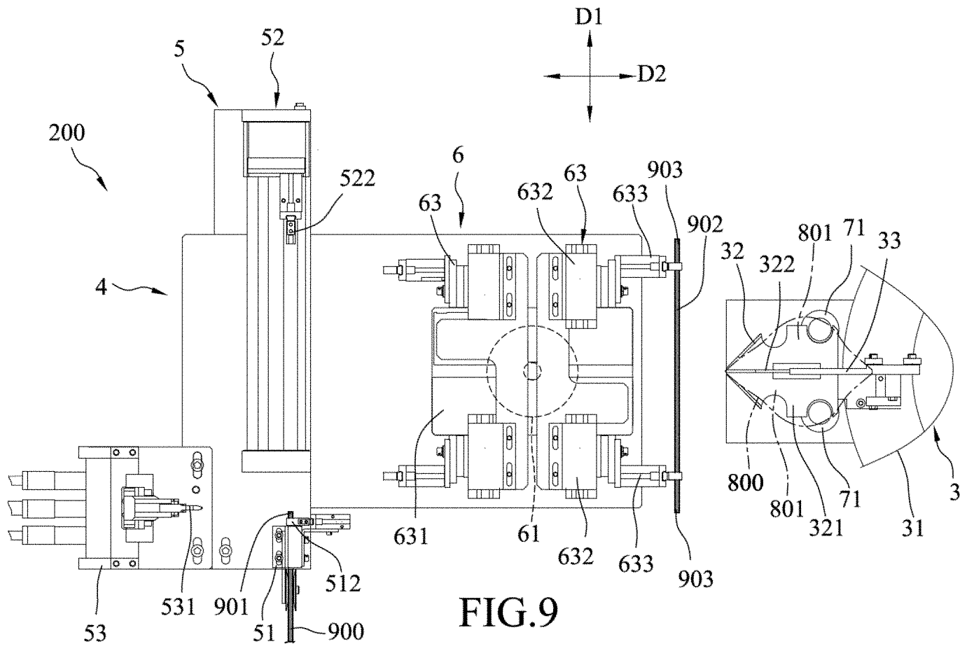

Referring to FIGS. 8 and 9, next, the translating unit 631 of the conveying device 63 at the clamping position is driven to move the driving units 632 and the clamping units 633 toward the string pulling device 52, and the clamping units 633 are driven to clamp the string 900. Then, the string cutting device 53 is driven to cut the string 900 to form the strap 902 that is clamped between the clamping units 633. The translating unit 631 is then driven to drive the driving units 632 and the clamping units 633 to return to their original positions.

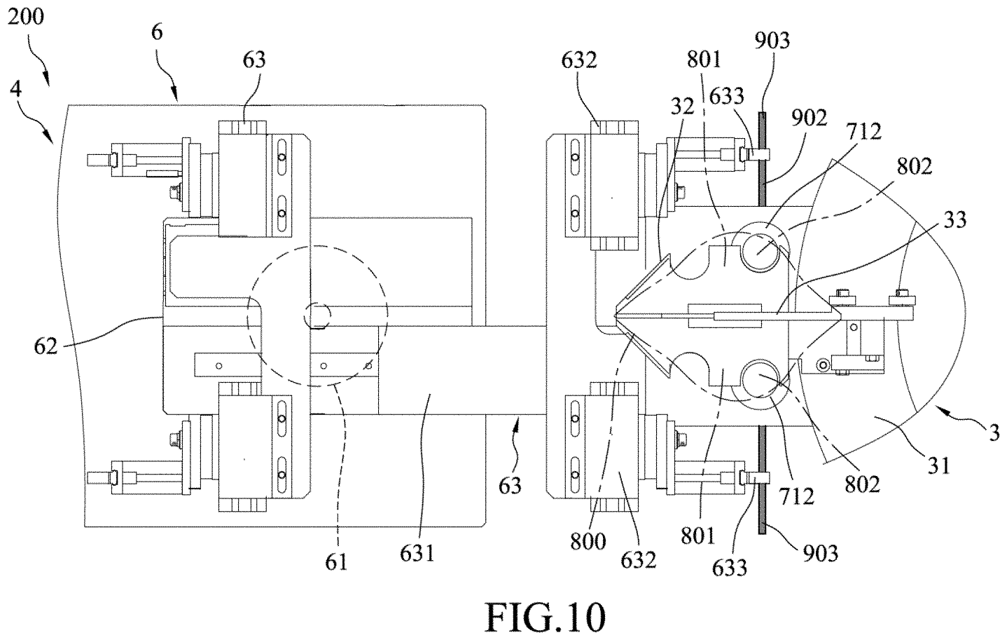

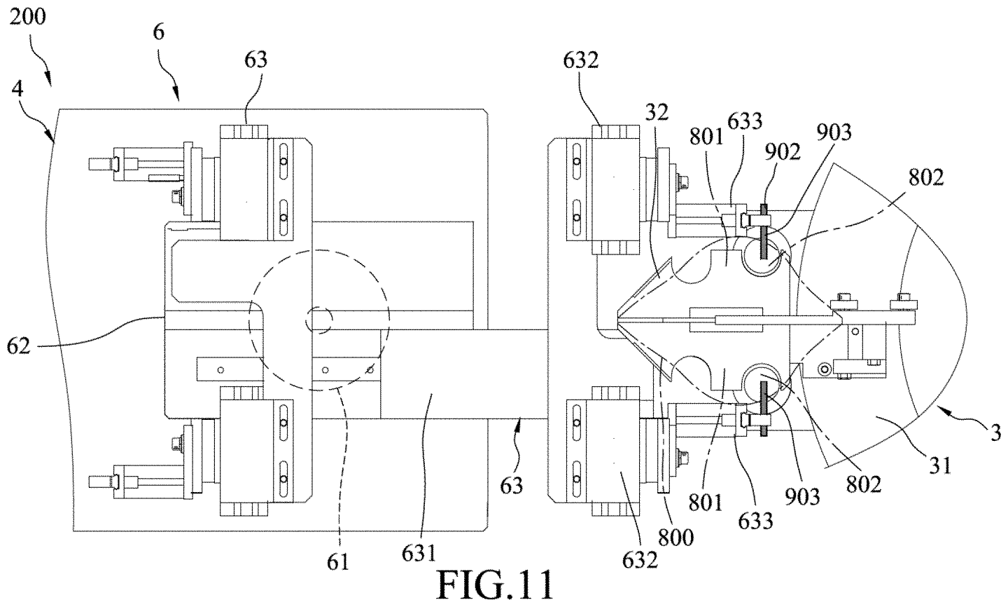

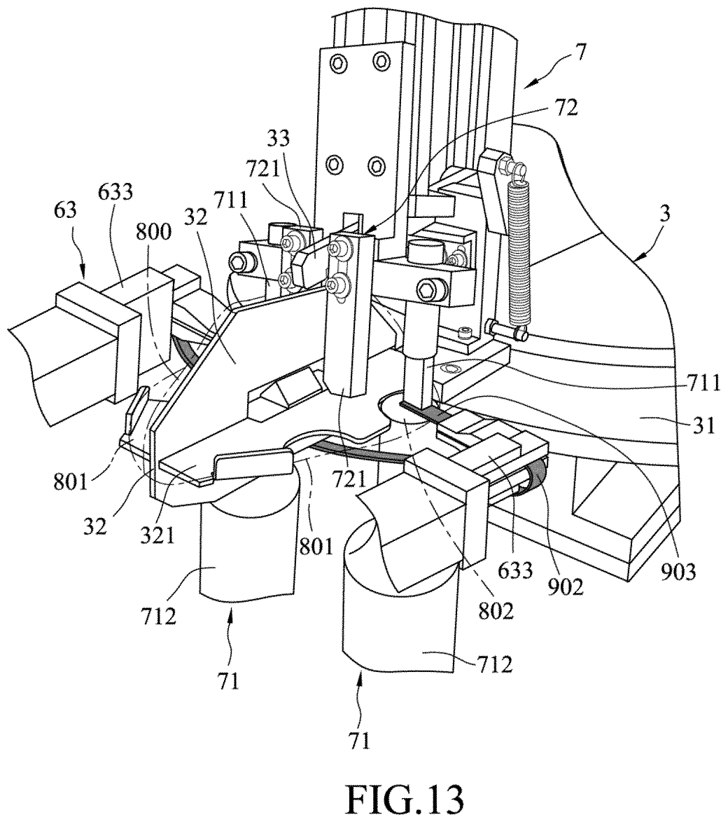

Referring to FIGS. 10, 11, and 13, after that, the driving device 61 of the strap conveying apparatus 6 drives the rotating seat 62 to rotate, interchanging the positions of the conveying devices 63, so that the conveying device 63 clamping the strap 902 is rotated to the feeding position. Then, the translating unit 631 of the conveying device 63 at the feeding position is driven to move the driving units 632 and the clamping units 633 toward the carrying frame 32, and the strap 902 is moved to the location under the carrying frame 32. The driving units 632 then drive the clamping units 633 to turn upwardly so as to move the ends 903 of the strap 902 to contact the first strap fixing regions 802 of the cover body 800.

Next, the strap fixing apparatus 7 is driven such that the positioning device 72 presses the cover body 800 against the carrying frame 32, and at the same time makes the abutment seat 711 and the heater 712 of the hot pressing devices 71 move vertically toward each other, clamping and hot-melting the ends 903 of the strap 902 and the cover body 800 together such that the ends 903 of the strap 902 are bonded respectively to the first strap fixing regions 802. Then, the positioning device 72 and the hot pressing devices 71 are moved away from the carrying frame 32 and return to their original positions. At this time, the process of bonding the strap 902 to the first strap fixing regions 802 of the cover body 800 is completed.

Then, the transferring mechanism 31 is driven to transfer the carrying frame 32 to the second processing position (C), and the strap mounting mechanism 4′ corresponding to the second processing position (C) is operated to perform the above processing steps, so as to transfer the additional strap 902 and bond the same to the second strap fixing regions 803 of the cover body 800.

It should be noted that, by virtue of the strap conveying apparatus 6 having two conveying devices 63, when one of the conveying devices 63 disposed at the feeding position is driven to transfer the strap 902 to the cover body 800 in order for the strap fixing apparatus 7 to bond the strap 902 to the cover body 800, the feeding apparatus 5 and the other one of the transfer device 63 disposed at the clamping position are driven respectively to generate and clamp the additional strap 902. Therefore, by rotating the conveying devices 63, the additional strap 902 can be successively bonded to another cover body 800 transferred by the cover carrying mechanism 3, increasing the processing speed. However, in other embodiments of the disclosure, the strap conveying apparatus 6 may only include one conveying device 63.

It should also be noted that, in the present embodiment, the cover body 800 of the mask has a 3D cup shape. However, in variations of the embodiment, the mask manufacturing machine 200 may also be used to manufacture a mask having a flat cover body (e.g., in such variations, configuration of the carrying frame 32 is modified so as to provide horizontal support for the flat cover body).

In sum, by virtue of the configurations of the cover carrying mechanism 3 and the strap mounting mechanism 4 of the present embodiment of the mask manufacturing machine 200, the straps 902 can be automatically manufactured and then bonded to the cover body 800 of the mask. In addition, the configuration of the carrying frame 32 equips the present embodiment with the ability to manufacture 3D masks, rendering it an innovative automated mask manufacturing machine.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A mask manufacturing machine adapted for processing and bonding a strap onto a cover body so as to manufacture a mask, and comprising:
a cover carrying mechanism including a carrying frame adapted for supporting and positioning the cover body thereon; and
at least one strap mounting mechanism including
a strap conveying apparatus that includes at least one conveying device adapted for conveying the strap to a location under the carrying frame, said at least one conveying device having two driving units that are spaced apart from each other, and two clamping units that are mounted respectively to the driving units and that are adapted for clamping respectively two opposite ends of the strap, each of said clamping units being drivable by a respective one of said driving units to turn upwardly, so as to move a respective one of the ends of the strap to contact a top surface of the cover body, and
a strap fixing apparatus that includes two spaced-apart hot pressing devices, each of said hot pressing devices being adapted for bonding the respective one of the ends of the strap to the top surface of the cover body by hot-melting.

2. The mask manufacturing machine as claimed in claim 1, wherein each of said hot pressing device includes a heater and an abutment seat that are disposed under and over the carrying frame, respectively, and that are drivable to move vertically toward each other, so as to clamp and hot-melt a corresponding one of the ends and the cover body together.

3. The mask manufacturing machine as claimed in claim 2, wherein said strap fixing apparatus further includes a positioning device that is disposed over said carrying frame and that is movable synchronously with said heater and said abutment seat to press the cover body against said carrying frame for positioning the cover body.

4. The mask manufacturing machine as claimed in claim 3, the cover body including two cloth pieces connected together to form a cup shape with an opening facing downward, wherein:
said carrying frame has
a base seat adapted for the two cloth pieces of the cover body to be disposed thereon, and
a supporting piece extending upwardly from a top surface of said base seat and adapted for supporting a middle portion of the cover body such that the middle portion is higher than the rest of the cover body;
said cover carrying mechanism further includes a presser being drivable to press the middle portion of the cover body against said supporting piece for positioning the middle portion of the cover body; and
said positioning device has two spaced-apart positioners adapted for positioning respectively the cloth pieces by pressing the same against said top surface of said base seat.

5. The mask manufacturing machine as claimed in claim 1, wherein:
said at least one strap mounting mechanism further includes a feeding apparatus that includes
a string guiding device adapted for a free end of the string to extend movably therethrough,
a string pulling device adapted for clamping and pulling the free end of the string away from said string guiding device, and
a string cutting device adapted for cutting the string after the free end is pulled away from said string guiding device such that a portion of the string which has the free end and which is cut off from the rest of the string forms the strap; and
said at least one conveying device is convertible between a clamping position, where said clamping unit is operated to clamp the strap, and a feeding position, where said clamping unit is disposed under said carrying frame.

6. The mask manufacturing machine as claimed in claim 5, wherein:
said strap conveying apparatus further includes a rotating seat and a driving device that is connected to said rotating seat for driving said rotating seat to rotate horizontally; and
said at least one conveying device is mounted to said rotating seat, and is co-rotatable with said rotating seat to convert between the clamping position and the feeding position.

7. The mask manufacturing machine as claimed in claim 6, wherein:
said at least one conveying device further includes a translating unit that is mounted to said rotating seat and that is horizontally movable relative to said rotating seat;
said driving units of said at least one conveying device are mounted to and co-movable with said translating unit;
when said at least one conveying device is at the clamping position, said driving units drive said clamping units to clamp the strap; and
when said at least one conveying device is converted from the clamping position to the feeding position, said driving units drive said clamping units to move the strap to the location under the carrying frame.

8. The mask manufacturing machine as claimed in claim 7, wherein said strap conveying apparatus includes two of said conveying devices, positions of which are interchanged when each of said conveying devices is converted between the clamping position and the feeding position.

9. The mask manufacturing machine as claimed in claim 5, the cover body having two first strap-fixing regions and two second strap-fixing regions, wherein:
said cover carrying mechanism further includes a transferring mechanism provided for said carrying frame to be mounted thereto and for transferring said carrying frame from a first processing position to a second processing position; and
said mask manufacturing machine includes two of said strap mounting mechanisms corresponding in position to the first processing position and the second processing position, respectively, said strap conveying apparatus of one of said strap mounting mechanisms being adapted to move the ends of the strap to contact respectively the two first strap fixing sections of the cover body, said strap conveying apparatus of the other one of said strap mounting mechanisms being adapted to move the ends of an additional strap to contact respectively two second strap fixing sections of the cover body.

10. The mask manufacturing machine as claimed in claim 9, wherein:
said string pulling device includes an adjustment unit and a string puller that is mounted to said adjustment unit; and
said adjustment unit is drivable to move said string puller between a holding position, where said string puller is proximate to said string guiding device and where said string puller is operated to clamp the free end of the string, and a pulled-away position, where said string puller is distal from said string guiding device, such that the free end of the string is pulled away from said string guiding device when said string puller is moved from the holding position to the pulled-away position.
